(19) United States
(12) Patent Application Publication
(10) Pub. No.: US 2011/0257066 A1
(43) Pub. Date: Oct. 20, 2011

(54) Detergent Composition

(76) Inventors: Nigel Patrick Somerville Roberts, Newcastle (GB); Hossam Hassan Tantawy, Northumberland (GB); James Robert Lickiss, Northumberland (GB); Paul R. Mort, III, Cincinnati, OH (US)

(21) Appl. No.: 13/083,901

(22) Filed: Apr. 11, 2011

Related U.S. Application Data
(60) Provisional application No. 61/325,430, filed on Apr. 19, 2010.

(51) Int. Cl. C11D 3/60

(52) U.S. Cl. 510/326; 510/351; 510/324

(57) ABSTRACT

Preparation of solid free flowing detergent composition by spray drying a chemically simple slurry as well as compositions comprising chemically simple spray dried particles

### CROSS REFERENCE TO RELATED APPLICATION

This application claims the benefit of U.S. Provisional Application No. 61/325,430, filed Apr. 19, 2010.

### FIELD OF THE INVENTION

The present invention concerns the preparation of solid free flowing detergent composition by spray drying a chemically simple slurry. The invention also concerns compositions comprising chemically simple spray dried particles.

### BACKGROUND OF THE INVENTION

Spray-drying is the standard method for manufacturing laundry detergent base powder. Typically, detergent ingredients are mixed together to form an aqueous detergent slurry in a mixer, such as a crutcher mixer. This slurry is then transferred through at least one pump to a spray nozzle, and the slurry is sprayed into a spray-drying tower, and spray-dried to form a spray-dried powder.

Typically, multiple chemically different formulations are manufactured on the same spray-drying equipment. This leads to the production of excessive quantities of unwanted material during the change over from one formulation to another. This is due to the need to flush the first formulation ingredients out of the spray-drying equipment, such as flushing the drop tank and pipe leading to the spray nozzle. In addition, there is an unwanted excessive time delay between manufacturing runs whilst this flushing is carried out. This reduces the overall efficiency and production capacity of the spray-dying process.

Also, when processing a new detergent composition, the skilled person needs to completely rework the processing of the new detergent composition. In particular, the skilled person needs to develop a new slurry to be spray dried. For example, ingredients that were typically spray dried and which are no longer present in the new detergent composition or which are present in a lower quantity, have to be removed (at least partially) from the slurry. This in turns leads to additional needs for optimization of the spray drying step; to rework the inorganic/organic ratio or to find new optimal parameters to operate the spray drying tower.

The choice of the composition of the spray dried particles will then impact the composition of the remaining particles. This will lead to a need of close coordination between the different teams working on different parts of the process.

The Inventors have found that the above problems could be alleviated by spray drying a slurry which is more universal in the sense that the slurry has such a chemical composition that it is compatible with a large number of detergent compositions. The other detergent ingredients to bring chemical differentiation or adjust the density may be added separately.

### SUMMARY OF THE INVENTION

As such, according to one of its embodiment, the invention concerns a solid free flowing particulate laundry detergent composition comprising:

(i) from 30 wt % to 90 wt % of a spray dried base detergent particle population comprising:
(a) from 10 wt % to 45 wt % of anionic detersive surfactant, wherein the anionic detersive surfactant comprises alkylbenzene sulphonate;
(b) from 20 wt % to 84 wt % of a compound selected from: sulphate salt; alluminosilicate builder; phosphate builder; chloride salt; carbonate salt; citrate salt; bicarbonate salt; hydroxide salt; and mixtures thereof;
(c) from 0 wt % to 20 wt % of polymeric material; and
(d) from 0 wt % to 10 wt % water and other detergent ingredients,

wherein the base detergent particle population comprises no more than two other detergent ingredients; and

(ii) from 10 wt % to 70 wt % other detergent particle population(s) comprising:
(a) from 1 wt % to 100 wt % of polymeric material;
(b) from 0 wt % to less than 10 wt % of anionic detersive surfactant;
(d) from 0 wt % to 4 wt % chelant;
(e) from 0 wt % to 4 wt % brightener;
(f) from 0 wt % to 4 wt % hueing agents;
(g) from 0 wt % to 99 wt % bleach;
(h) from 0 wt % to 40 wt % clay;
(i) from 0 wt % to 30 wt % cationic surfactant; and
(j) from 0 wt % to 99% of other ingredients,

wherein at least 5 wt % of the particles have a bulk density of less than 400 g/l, wherein at least 15 wt % of the particles have a bulk density of greater than 900 g/l, and wherein the bulk density of the particulate composition is in the range of from 500 g/l to 800 g/l.

The base detergent particle population may be produced by spray-drying an aqueous common base slurry. The other detergent particle population(s) may be prepared by spray drying, or by agglomeration or any other suitable process. At least part of the other detergent particle population(s) may be produced by spray-drying an aqueous polymer base slurry.

The specific densities may be obtained by adding separate particles to adjust the density.

The composition may comprise from 0.5 wt % to 5 wt % liquid ingredients that are absorbed and/or adsorbed onto at least part of, or all of the particles.

The invention also concerns according to one of its embodiments a process for preparing a solid free flowing particulate laundry detergent composition comprising the steps of:
(i) preparing an aqueous common base slurry comprising on a dry basis:
   from 6 wt % to 45 wt % of alkylbenzene sulphonate, and a total amount of anionic surfactant of from 6 wt % to 45 wt %,
   from 20 wt % to 84 wt % of a compound selected from sodium sulphate, alluminosilicate builder, phosphate builder, from salts of chloride, carbonate, citrate, bicarbonate, and mixtures thereof,
   from 0 wt % to 10 wt % of polymeric material,
   from 0 wt % to 10 wt % of other ingredients,
(ii) preparing an aqueous polymer base slurry comprising on a dry basis:
   from 1 wt % to 100 wt % of polymeric material,
   from 0 wt % to 6 wt % of alkylbenzene sulphonate, and a total amount of anionic surfactant of from 0 wt % to 35 wt %,
   from 0 wt % to 99% of other ingredients,
(iii) Obtaining a spray dried powder from the common base slurry and the aqueous polymer base slurry by spray drying them,
wherein the weight ratio of the percentage of polymeric material in the aqueous common base slurry to the percentage of polymeric material in the aqueous polymer base slurry is below 0.8, and
wherein the weight ratio of the percentage of of alkylbenzene sulphonate in the aqueous polymer base slurry to the percentage of alkylbenzene sulphonate in the aqueous common base slurry is below 0.8.

The aqueous common base slurry and the aqueous polymer base slurry may be sprayed in the same spray dried tower or in different spray dried tower. Preferably the two slurries are co-sprayed in the same tower.

Preferably, the two slurries are sprayed from separate nozzles in the spray dried tower. Preferably, the nozzles are at different height in the spray dried tower. The two slurries may be sprayed at different temperatures and at different pressure.

The inventors have found that it was preferable to spray dry polymeric material and anionic surfactant such as alkylbenzene sulphonate under different spray drying condition.

As such, spraying the aqueous common base slurry comprising a high weight percentage of alkylbenzene sulphonate and a low level of polymeric material separately from the aqueous polymer base slurry comprising a lower weight percentage of anionic surfactant and a higher level of polymeric material may leads to free flowing detergent composition which have improved physical properties like smaller particles and may lead to a spray drying process having an improved drying efficiency.

### DETAILED DESCRIPTION OF THE INVENTION

### Solid Free Flowing Particulate Laundry Detergent Composition

According to an embodiment of the invention, the solid free flowing particulate laundry detergent composition comprises from 30 wt % to 90 wt %, preferably from 40 wt % to 60 wt % of a spray dried base detergent particle population comprising:
(a) from 10 wt % to 45 wt %, preferably from 15 wt % to 30 wt % of anionic detersive surfactant, wherein the anionic detersive surfactant comprises alkylbenzene sulphonate;
(b) from 20 wt % to 84 wt %, preferably from 40 wt % to 75 wt % of a compound selected from: sulphate salt; alluminosilicate builder; phosphate builder; chloride salt; carbonate salt; citrate salt; bicarbonate salt; hydroxide salt; and mixtures thereof;
(c) from 0 wt % to 20 wt %, preferably from 0 wt % to 5 wt % of polymeric material; and
(d) from 0 wt % to 10 wt %, preferably from 0 wt % to 6 wt % water and other detergent ingredients,
   wherein the base detergent particle population comprises no more than two other detergent ingredients, preferably no more that one detergent ingredients.

The other detergent ingredients do not includes impurities which are present in the other detergent ingredients but only the deliberately added detergent ingredients.

According to an embodiment of the invention, the solid free flowing particulate laundry detergent composition comprises from 10 wt % to 70 wt %, preferably from 40 wt % to 60 wt % other detergent particle population(s) comprising:
(a) from 1 wt % to 100 wt %, preferably from 5 wt % to 75 wt % of polymeric material;
(b) from 0 wt % to less than 10 wt %, preferably from 1 wt % to 8 wt % of anionic detersive surfactant;
(d) from 0 wt % to 4 wt % chelant;
(e) from 0 wt % to 4 wt % brightener;
(f) from 0 wt % to 4 wt % hueing agents;
(g) from 0 wt % to 99 wt % bleach;
(h) from 0 wt % to 40 wt % clay;
(i) from 0 wt % to 30 wt % cationic surfactant; and
(j) from 0 wt % to 99% of other ingredients.

The other detergent particle population may comprise at least 2, or even at least 3, or even at least 4 or 5, or 6 or 7 of the ingredients chosen from chelant, brightener, hueing agent, bleach, clay, cationic surfactant, anionic surfactant other than alkylbezene sulphonate. Each of this ingredient may be present in a quantity of more than 0.1% or 1% per weight of the other detergent particle population.

According to an embodiment of the invention, at least 5 wt % or 10 wt % of the particles of the solid free flowing particulate laundry detergent composition have a bulk density of less than 400 g/l, at least 15 wt % or 20 wt % of the particles have a bulk density of greater than 900 g/l, and the bulk density of the particulate composition is in the range of from 500 g/l to 800 g/l or 550 g/l to 750 g/l.

The free flowing particulate laundry detergent composition may comprise at least 25 or 30 or 35 or 40 wt % of spray dried ingredients coming from the aqueous common base slurry, and/or at least 10 wt % or 15 wt % or 20 wt % of spray dried ingredient coming from the aqueous polymer base slurry as defined below.

### Polymeric Material

The solid free flowing particulate laundry detergent composition comprises a polymeric material. The polymeric material may have a molecular weight of more than 1000 g/mol or 2000 g/mol or 4000 g/mol.

### Anionic Surfactant

The solid free flowing particulate laundry detergent composition comprises an anionic surfactant. The anionic surfactant comprises alkylbenzene sulphonate.

The spray dried base detergent particle population may comprise from 6 wt % to 45 wt %, preferably from 10 wt % or from 15 wt % to 30 wt % of anionic detersive surfactant. The spray dried base detergent particle population may comprise from 6 wt % to 45 wt %, preferably from 10 wt % or from 15 wt % to 30 wt % alkylbenzene sulphonate.

The detergent composition may comprise from 2% to 50% by weight, preferably from 1% to 25% by weight, in particular from 3% to 20% or from 5% to 15% by weight of anionic surfactant.

The alkylbenzene sulfonate may be linear branched, and/or modified.

### Linear, Branched, and Modified Alkylbenzene Sulfonate

Other suitable anionic surfactants useful herein include any of the conventional anionic surfactant types typically used in detergent products. These include alkyl benzene sulfonates as well as alkoxylated or non-alkoxylated alkyl sulfates.

Exemplary anionic surfactants are C₁₀₋₁₆ alkyl benzene sulfonates, preferably C₁₁₋₁₄ alkyl benzene sulfonates. In one embodiment, the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Preferred are the linear straight chain alkylbenzene sulfonates in which the average number of carbon atoms in the alkyl group is from about 11 to 14. Particularly, C₁₁-C₁₄, e.g., C₁₂, and LAS is a specific example of such surfactants.

Other exemplary akylbenzene sulfonates include modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548.

MLAS may comprise a mixture, preferably consisting essentially of: (a) from about 15% to about 99%, preferably from about 15% to about 60%, more preferably from about 20% to about 40%, by weight of a mixture of branched alkylbenzene sulfonates having formula:

L(R¹)(R²)-A-SO₃⁻

wherein L is an acyclic aliphatic moiety consisting of carbon and hydrogen, the L having two methyl termini and the L having no substituents other than A, R¹ and R²; and wherein the mixture of branched alkylbenzene sulfonates contains two or more, preferably at least three, optionally more, of the branched alkylbenzene sulfonates differing in molecular weight of the anion of the formula (I), and wherein the mixture of branched alkylbenzene sulfonates has a sum of carbon atoms in R¹, L and R² of from 9 to 15, preferably from 10 to 14; an average aliphatic carbon content, i.e., based on R¹, L and R² and excluding A, of from about 10.0 to about 14.0, preferably from about 11.0 to about 13.0, more preferably from about 11.5 to about 12.5, carbon atoms; R¹ is C₁-C₃ alkyl, preferably C₁-C₂ alkyl, more preferably methyl; R² is selected from H and C₁-C₃ alkyl, preferably H and C₁-C₂ alkyl, more preferably H and methyl, more preferably H and methyl provided that in at least about 0.5, more preferably 0.7, more preferably 0.9 to 1.0 mole fraction of the branched alkylbenzene sulfonates, R² is H; A is a benzene moiety, typically A is the moiety-C₆H₄—, with the SO₃⁻ moiety of Formula (I) in para-position to the L moiety, though in some proportion, usually no more than about 5%, preferably from 0 to 5% by weight, the SO₃⁻ moiety is ortho-to L; and (b) from about 1% to about 85%, preferably from about 40% to about 85%, more preferably from about 60% to about 80%, by weight of a mixture of nonbranched alkylbenzene sulfonates having formula:

Y-A-SO₃⁻

wherein A is as defined hereinbefore and Y is an unsubstituted linear aliphatic moiety consisting of carbon and hydrogen having two methyl termini, and wherein the Y has a sum of carbon atoms of from 9 to 15, preferably from 10 to 14, and the Y has an average aliphatic carbon content of from about 10.0 to about 14.0, preferably from about 11.0 to about 13.0, more preferably 11.5 to 12.5 carbon atoms; and wherein the modified alkylbenzene sulfonate surfactant mixture is further characterized by a 2/3-phenyl index of from about 160 to about 275, preferably from about 170 to about 265, more preferably from about 180 to about 255; and also preferably wherein the modified alkylbenzene sulfonate surfactant mixture has a 2-methyl-2-phenyl index of less than about 0.3, preferably less than about 0.2, more preferably less than about 0.1, more preferably still, from 0 to 0.05.

In addition to the alkylbenzene sulphonate(s), the anionic surfactant may comprise surfactants selected from alkyl ester sulfonate(s); C₁₀-C₁₈ alkyl alkoxy sulfates; C₁₀-₂₀ primary, branched-chain and random alkyl sulfates; C₁₀-C₁₈ secondary (2,3) alkyl sulfates; C₁₀-C₁₈ alkyl alkoxy carboxylate(s); mid-chain branched alkyl sulfate(s); mid-chain branched alkyl alkoxy sulfate(s); alpha-olefin sulfonate(s); phosphate ester(s); and mixtures thereof.

### Alkyl Ester Sulfonate Surfactant (“MES”)

As used herein, “MES” refers to alkyl ester sulfonate surfactants, commonly used in methyl ester sulfonate form. MES surfactants useful herein include sulfonated fatty acid alkyl esters of the formula R—CH(SO₃⁻)—COOR′, wherein R is, on the average, a C₆ to C₂₂ alkyl and R′ is on the average a C₁ to C₈ alkyl.

The hydrophobic portion of these sulfonated alkyl esters have the sulfonate group at the α-position, i.e., the sulfonate group is positioned at the carbon atom adjacent to the carbonyl group. The alkyl portion of the hydrophobic portion, which corresponds to the R portion of the sulfonated fatty acid alkyl esters, is on the average a C₆ to C₂₂ alkyl. Preferably, the alkyl portion of this hydrophobic portion, R, has a straight-chain of an average length C₈ to C₁₆ hydrocarbon particularly when R′ is methyl.

R′, forming the ester portion of the sulfonated alkyl esters, is on the average a C₁ to C₈ alkyl. Preferably, R′ is on the average a C₁ to C₆ alkyl, and most preferably a C₁ alkyl, i.e., methyl.

In one embodiment, the distribution is such that R is, on the average, a C₁₄ to C₁₆ alkyl (approximately, for example, a 95% C₁₄, 5% C₁₆ mixture) and R′ is methyl. In another embodiment, the distribution is such that R is, on the average, a C₁₂ to C₁₆ alkyl (approximately, for example, a 3% C₁₂, 28% C₁₄, 69% C₁₆ mixture) and R′ is methyl. In yet another embodiment, the distribution is such that R is, on the average, a C₁₀ to C₁₆ alkyl (approximately, for example, a 60% C₁₀, 35% C₁₂, 5% C₁₄ mixture) and R′ is methyl. In yet another embodiment, the distribution is such that R is, on the average, a C₁₂ to C₁₄ alkyl (approximately, for example, a 65% C₁₂, 30% C₁₄ mixture). In yet a further embodiment, blends of the aforementioned distributions of R and R′ may also be employed. In one embodiment, the methyl ester sulfonate has an average carbon length of about 16. In other embodiments, R′ could be ethyl (C₂), n-propyl & i-propyl (C₃), n-butyl, i-butyl (C₄), n-pentyl (C₅) and n-hexyl (C₆).

Methods of making alkyl ester surfactants neutralized with an alkali metal or an alkaline earth metal have been well described and are known to those skilled in art the art. See, for example, U.S. Pat. Nos. 4,671,900; 4,816,188; 5,329,030; 5,382,677; 5,384,422; 5,475,134; 5,587,500; 6,780,830. MES as such is commercially available from Huish.

### Linear, Branched, and Modified Alkylbenzene Sulfonate

Other suitable anionic surfactants useful herein include any of the conventional anionic surfactant types typically used in detergent products. These include alkyl benzene sulfonates as well as alkoxylated or non-alkoxylated alkyl sulfates.

Exemplary anionic surfactants are C₁₀₋₁₆ alkyl benzene sulfonates, preferably C₁₁₋₁₄ alkyl benzene sulfonates. In one embodiment, the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Preferred are the linear straight chain alkylbenzene sulfonates in which the average number of carbon atoms in the alkyl group is from about 11 to 14. Particularly, C₁₁-C₁₄, e.g., C₁₂, and LAS is a specific example of such surfactants.

Other exemplary alkylbenzene sulfonates include modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548.

MLAS may comprise a mixture, preferably consisting essentially of: (a) from about 15% to about 99%, preferably from about 15% to about 60%, more preferably from about 20% to about 40%, by weight of a mixture of branched alkylbenzene sulfonates having formula:

L(R¹)(R²)-A-SO₃⁻

wherein L is an acyclic aliphatic moiety consisting of carbon and hydrogen, the L having two methyl termini and the L having no substituents other than A, R¹ and R²; and wherein the mixture of branched alkylbenzene sulfonates contains two or more, preferably at least three, optionally more, of the branched alkylbenzene sulfonates differing in molecular weight of the anion of the formula (I), and wherein the mixture of branched alkylbenzene sulfonates has a sum of carbon atoms in R¹, L and R² of from 9 to 15, preferably from 10 to 14; an average aliphatic carbon content, i.e., based on R¹, L and R² and excluding A, of from about 10.0 to about 14.0, preferably from about 11.0 to about 13.0, more preferably from about 11.5 to about 12.5, carbon atoms; R¹ is C₁-C₃ alkyl, preferably C₁-C₂ alkyl, more preferably methyl; R² is selected from H and C₁-C₃ alkyl, preferably H and C₁-C₂ alkyl, more preferably H and methyl, more preferably H and methyl provided that in at least about 0.5, more preferably 0.7, more preferably 0.9 to 1.0 mole fraction of the branched alkylbenzene sulfonates, R² is H; A is a benzene moiety, typically A is the moiety-C₆H₄—, with the SO₃⁻ moiety of Formula (I) in para-position to the L moiety, though in some proportion, usually no more than about 5%, preferably from 0 to 5% by weight, the SO₃⁻ moiety is ortho-to L; and (b) from about 1% to about 85%, preferably from about 40% to about 85%, more preferably from about 60% to about 80%, by weight of a mixture of nonbranched alkylbenzene sulfonates having formula:

Y-A-SO₃⁻

wherein A is as defined hereinbefore and Y is an unsubstituted linear aliphatic moiety consisting of carbon and hydrogen having two methyl termini, and wherein the Y has a sum of carbon atoms of from 9 to 15, preferably from 10 to 14, and the Y has an average aliphatic carbon content of from about 10.0 to about 14.0, preferably from about 11.0 to about 13.0, more preferably 11.5 to 12.5 carbon atoms; and wherein the modified alkylbenzene sulfonate surfactant mixture is further characterized by a 2/3-phenyl index of from about 160 to about 275, preferably from about 170 to about 265, more preferably from about 180 to about 255; and also preferably wherein the modified alkylbenzene sulfonate surfactant mixture has a 2-methyl-2-phenyl index of less than about 0.3, preferably less than about 0.2, more preferably less than about 0.1, more preferably still, from 0 to 0.05.

### C₁₀-C₁₈ Alkyl Alkoxy Sulfates

Another exemplary type of anionic surfactant includes ethoxylated alkyl sulfate surfactants. Such materials, also known as alkyl ether sulfates or alkyl polyethoxylate sulfates, are those which correspond to the formula:

R′—O—(C₂H₄O)ₙ—SO₃⁻

wherein R′ is a C₈-C₂₀ alkyl group and n is from about 1 to 20. In a specific embodiment, R′ is C₁₀-C₁₈ alkyl and n is from about 0.1 to 15. In another embodiment, n is from about 1 to 15. In more specific embodiments, R′ is a C₁₂-C₁₆, n is from about 1 to 6. In the disclosure herein, the designation “EOx” indicates that the alkoxy group is an ethoxy group, the integer “x” indicates the number of ethoxy groups in each chain.

The alkyl ether sulfates will generally be used in the form of mixtures comprising varying R′ chain lengths and varying degrees of ethoxylation. Frequently, though the average n value may be more than zero, such mixtures will inevitably also contain some non-ethoxylated alkyl sulfate materials, i.e., individual surfactant molecules of the above ethoxylated alkyl sulfate formula wherein n=0 for that particular molecule.

### C₁₀₋₂₀ Primary, Branched-Chain and Random Alkyl Sulfates

Alkyl sulfates may also be added separately to the compositions of this invention and used as or in any anionic surfactant component which may be present. Specific examples of alkyl sulfates surfactants are those produced by the sulfation of higher C₁₀-C₂₀ fatty alcohols. Conventional primary alkyl sulfate surfactants have the general formula:

ROSO₃⁻

wherein R is typically a linear C₁₀₋C₂₀ alkyl group, which may be straight chain or branched chain. In specific embodiments, R is a C₁₀-C₁₅ alkyl, more specifically R is C₁₂-C₁₄.

### C₁₀-C₁₈ Secondary (2,3)Alkyl Sulfates

Another anionic surfactant useful herein includes secondary (2,3)alkyl sulfates having formulae CH₃—(CH₂)ₓ—CH(OSO₃⁻)—CH₃ or CH₃—(CH₂)_{y}—CH(OSO₃⁻)—CH₂—CH₃.

Non-limiting examples of a preferred secondary alkyl sulfate include the one where x is at least about 7, preferably at least about 9, and y is an integer of at least 8, preferably at least about 9.

### C₁₀-C₁₈ Alkyl Alkoxy Carboxylates

Another exemplary type of anionic surfactant includes ethoxylated alkyl carboxylate surfactants. Such materials, also known as alkyl ether carboxylates or alkyl polyethoxylate carboxylates, are those which correspond to the formula:

R′—O—(C₂H₄O)ₙ—COO⁻

wherein R′ is a C₈-C₂₀ alkyl group and n is an integer from about 1 to 20. In a specific embodiment, R′ is C₁₀-C₁₈ alkyl and/or n is from about 1 to 15. In more specific embodiments, R′ is a C₁₂-C₁₆ and/or n is from about 1 to 6.

The alkyl ether carboxylates will generally be used in the form of mixtures comprising varying R′ chain lengths and varying degrees of ethoxylation. Frequently such mixtures will inevitably also contain some non-ethoxylated alkyl carboxylate materials, i.e., surfactants of the above alkyl ether carboxylate formula wherein n=0.

### Mid-Chain Branched Alkyl Sulfates

Exemplary anionic surfactants include mid-chain branched alkyl sulfates as discussed in U.S. Pat. No. 6,020,303 and U.S. Pat. No. 6,060,443.

Mid-chain branched alkyl sulfates may comprise at least about 0.5%, preferably at least about 5%, more preferably at least about 10%, most preferably at least about 20%, by weight of longer alkyl chain, mid-chain branched surfactant compounds of the formula:

A^{b}-X—B

wherein:

(a) A^{b} is a hydrophobic C₉ to C₂₂ (total carbons in the moiety), preferably from about C₁₂ to about C₁₈, mid-chain branched alkyl moiety having: (1) a longest linear carbon chain attached to the —X—B moiety in the range of from 8 to 21 carbon atoms; (2) one or more C₁₋₃ alkyl moieties branching from this longest linear carbon chain; (3) at least one of the branching alkyl moieties is attached directly to a carbon of the longest linear carbon chain at a position within the range of position 2 carbon (counting from carbon #1 which is attached to the —X—B moiety) to position ω-2 carbon (the terminal carbon minus 2 carbons, i.e., the third carbon from the end of the longest linear carbon chain); and (4) the surfactant composition has an average total number of carbon atoms in the A^{b}-X moiety in the above formula within the range of greater than 14.5 to about 17.5 (preferably from about 15 to about 17);

(b) B is a hydrophilic moiety selected from sulfates; and

(c) X is selected from —CH₂— and —C(O)—.

Also preferred are mid-chain branched alkyl sulfates of the above formula wherein the A^{b} moiety does not have any quaternary substituted carbon atoms (i.e., 4 carbon atoms directly attached to one carbon atom).

Preferred mid-chain branched alkyl sulfates herein comprise longer alkyl chain, mid-chain branched surfactant compounds of the above formula wherein the A^{b} moiety is a branched primary alkyl moiety having the formula:

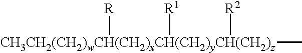

wherein the total number of carbon atoms in the branched primary alkyl moiety of this formula (including the R, R¹, and R² branching) is from 13 to 19; R, R1, and R2 are each independently selected from hydrogen and C₁-C₃ alkyl (preferably methyl), provided R, R¹, and R² are not all hydrogen and, when z is 0, at least R or R¹ is not hydrogen; w is from 0 to 13; x is from 0 to 13; y is from 0 to 13; z is from 0 to 13; and w+x+y+z is from 7 to 13.

Also preferred mid-chain branched alkyl sulfates comprise longer alkyl chain, mid-chain branched surfactant compounds of the above formula wherein the A^{b} moiety is a branched primary alkyl moiety having the formula selected from:

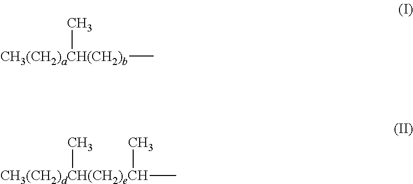

or mixtures thereof; wherein a, b, d, and e are integers, a+b is from 10 to 16, d+e is from 8 to 14 and wherein further when a+b=10, a is an integer from 2 to 9 and b is an integer from 1 to 8; when a+b=11, a is an integer from 2 to 10 and b is an integer from 1 to 9; when a+b=12, a is an integer from 2 to 11 and b is an integer from 1 to 10; when a+b=13, a is an integer from 2 to 12 and b is an integer from 1 to 11; when a+b=14, a is an integer from 2 to 13 and b is an integer from 1 to 12; when a+b=15, a is an integer from 2 to 14 and b is an integer from 1 to 13; when a+b=16, a is an integer from 2 to 15 and b is an integer from 1 to 14; when d+e=8, d is an integer from 2 to 7 and e is an integer from 1 to 6; when d+e=9, d is an integer from 2 to 8 and e is an integer from 1 to 7; when d+e=10, d is an integer from 2 to 9 and e is an integer from 1 to 8; when d+e=11, d is an integer from 2 to 10 and e is an integer from 1 to 9; when d+e=12, d is an integer from 2 to 11 and e is an integer from 1 to 10; when d+e=13, d is an integer from 2 to 12 and e is an integer from 1 to 11; when d+e=14, d is an integer from 2 to 13 and e is an integer from 1 to 12.

### Mid-Chain Branched Alkyl Alkoxy Sulfates

Still other exemplary anionic surfactants include mid-chain branched alkyl alkoxy sulfates as discussed in U.S. Pat. No. 6,008,181 and U.S. Pat. No. 6,020,303

Mid-chain branched alkyl alkoxy sulfates comprise from about 0.001% to about 100% of one or more (preferably a mixture of two or more) mid-chain branched primary alkyl alkoxylated sulfates having the formula:

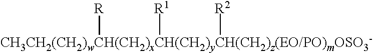

wherein the total number of carbon atoms in the branched primary alkyl moiety of this formula (including the R, R¹, and R² branching, but not including the carbon atoms in the EO/PO alkoxy moiety) is from 14 to 20, and wherein further for this surfactant mixture the average total number of carbon atoms in the branched primary alkyl moieties having the above formula is within the range of greater than 14.5 to about 17.5 (preferably from about 15 to about 17); R, R¹, and R² are each independently selected from hydrogen and C₁-C₃ alkyl (preferably methyl), provided R, R¹, and R² are not all hydrogen and, when z is 1, at least R or R¹ is not hydrogen; w is an integer from 0 to 13; x is an integer from 0 to 13; y is an integer from 0 to 13; z is an integer of at least 1; w+x+y+z is from 8 to 14; and EO/PO are alkoxy moieties including for example ethoxy, propoxy, butoxy, etc, preferably selected from ethoxy, propoxy, and mixed ethoxy/propoxy groups, most preferably ethoxy, wherein m is at least about 0.01, preferably within the range of from about 0.1 to about 30, more preferably from about 0.5 to about 10, and most preferably from about 1 to about 5. It is to be recognized that the (EO/PO)ₘ moiety may be either a distribution with average degree of alkoxylation corresponding to m, or it may be a single specific chain with alkoxylation (e.g., ethoxylation and/or propoxylation) of exactly the number of units corresponding to m.

Preferably, the mid-chain branched alkyl alkoxy sulfates comprise a mixture of mid-chain branched primary alkyl alkoxylated sulfate surfactants, said mixture comprising at least about 5% by weight of two or more mid-chain branched primary alkyl alkoxylated sulfates having the formula:

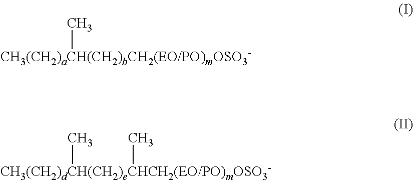

or mixtures thereof; wherein a, b, d, and e are integers, a+b is from 10 to 16, d+e is from 8 to 14 and wherein further when a+b=10, a is an integer from 2 to 9 and b is an integer from 1 to 8; when a+b=11, a is an integer from 2 to 10 and b is an integer from 1 to 9; when a+b=12, a is an integer from 2 to 11 and b is an integer from 1 to 10; when a+b=13, a is an integer from 2 to 12 and b is an integer from 1 to 11; when a+b=14, a is an integer from 2 to 13 and b is an integer from 1 to 12; when a+b=15, a is an integer from 2 to 14 and b is an integer from 1 to 13; when a+b=16, a is an integer from 2 to 15 and b is an integer from 1 to 14; when d+e=8, d is an integer from 2 to 7 and e is an integer from 1 to 6; when d+e=9, d is an integer from 2 to 8 and e is an integer from 1 to 7; when d+e=10, d is an integer from 2 to 9 and e is an integer from 1 to 8; when d+e=11, d is an integer from 2 to 8 and e is an integer from 1 to 9; when d+e=12, d is an integer from 2 to 11 and e is an integer from 1 to 10; when d+e=13, d is an integer from 2 to 12 and e is an integer from 1 to 11; when d+e=14, d is an integer from 2 to 13 and e is an integer from 1 to 12; wherein for this surfactant mixture the average total number of carbon atoms in the branched primary alkyl moieties having the above formulas is within the range of greater than 14.5 to about 17.5; and wherein EO/PO are alkoxy moieties, preferably selected from ethoxy, propoxy, and mixed ethoxy/propoxy groups, wherein m is at least about 0.01, preferably within the range of from about 0.1 to about 30, more preferably from about 0.5 to about 10, and most preferably from about 1 to about 5.

The mid-chain branched alkyl alkoxy sulfates may comprise compounds of formula:

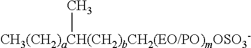

wherein: a is an integer from 2 to 11, b is an integer from 1 to 10, and a+b is 8 or 9; and EO/PO are alkoxy moieties, preferably selected from ethoxy, propoxy, and mixed ethoxy/propoxy groups, wherein m is at least about 0.01, preferably within the range of from about 0.1 to about 30, more preferably from about 0.5 to about 10, and most preferably from about 0.6 to about 5.

Also preferred herein are alkoxylated sulfate compounds of formula:

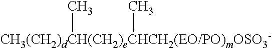

wherein: d and e are integers and d+e is 6 or 7; and wherein further when d+e=6, d is an integer from 2 to 5 and e is an integer from 1 to 4; when d+e=7, d is an integer from 2 to 6 and e is an integer from 1 to 5; and EO/PO are alkoxy moieties, preferably selected from ethoxy, propoxy, and mixed ethoxy/propoxy groups, wherein m is at least about 0.01, preferably within the range of from about 0.1 to about 30, more preferably from about 0.5 to about 10, and most preferably from about 0.6 to about 5.

### Alpha-Olefin Sulfonate

Other anionic surfactants useful in embodiments of the present disclosure include olefin sulfonates, which are compounds produced by the sulfonation of alpha-olefin by means of uncomplexed sulfur trioxide followed by neutralization of the acid reaction mixture under conditions such that sultones formed in the reaction are hydrolyzed to give corresponding hydroxyalkanesulfonates. The alpha-olefins from which the olefin sulfonates are derived are mono-olefins having from about 8 to about 24 carbon atoms, preferably from about 12 to about 16 carbon atoms. Preferably, they are straight chain olefins. Exemplary alpha-olefin sulfonates for use in the disclosure herein have the general formula:

R—CH═CH—CH2-SO₃⁻ (2,3-alkenylsulfonate) or R—CH(OH)—CH2-CH2-SO₃⁻ (3-hydroxy-alkanesulfonate,

where R is a linear or branched alkyl of about 8 to 20 carbon atoms. Examples of suitable alpha-olefins include 1-olefins such as 1-dodecene, 1-tetradecene, 1-hexadecene, 1-octadecene, 1-eicosene and 1-tetracosene.

### Phosphate Esters

Other anionic surfactants useful in embodiments of the present disclosure include phosphate esters. Phosphate esters are any materials of the general formula:

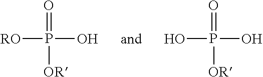

wherein R and R′ are C₆-C₂₀ alkyl or ethoxylated alkyl groups. Preferably R and R′ are of the general formula:

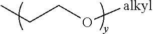

wherein the alkyl substituent is C₁₀-C₁₆ and Y is between 0 and about 4. Most preferably the alkyl substituent of that formula is C₁₀-C₁₆ and Y is between about 2 and about 4. Such compounds may be prepared by known methods from phosphorus pentoxide, phosphoric acid, or phosphorus oxy halide and alcohols or ethoxylated alcohols.

It will be appreciated that the formula depicted represent mono- and di-esters, and commercial phosphate esters will generally comprise mixtures of the mono- and di-esters, together with some proportion of tri-ester.

### Fatty Acids

Preferably, the anionic surfactant comprises less than 3% or even less than 1% or 0.1% by weight of fatty acids. The detergent composition may comprise no fatty acids.

Fatty acids have the general formula:

RCOO⁻

wherein R is typically a C₉-C₂₁ alkyl group, which may be straight chain or branched chain. In specific embodiments, R is a C₉-C₁₇ alkyl, and more specifically R is C₁₁-C₁₅.

Exemplary fatty acids are selected from the group consisting of lauric acid, tridecylic acid, myristic acid, pentadecylic acid, palmitic acid, margaric acid, stearic acid, arachidic acid, phytanic acid, behenic acid, palmitoleic acid, oleic acid, elaidic acid, vaccenic acid, linoleic acid, cis-eleostearic acid, trans-eleosteric acid, linolenic acid, arachidonic acid and combinations thereof. Fatty acids can be saturated or unsaturated. Unsaturated fatty acids typically having an iodine value from 15 to 25, preferably from 18 to 22 and a cis:trans isomer ratio from 1:1 to 200:1, preferably for 10:1 to 200:1.

Sources of fatty acid are coconut, soybean, tallow, palm, palm kernel, rapeseed, lard, sunflower, corn, safflower, canola, olive, peanut.

The weight ratio of mono alcohol(s) having a main chain comprising from 14 to 18 carbon atoms and being linear or branched with 1 or 2 substituent(s), the 1 or 2 substituent(s) being methyl and/or ethyl to the total amount of anionic surfactant(s) comprised in the detergent composition is comprised between 0.01 and 0.1, preferably between 0.02 and 0.05, for example is above 0.03 and/or below 0.04.

The detergent composition may comprise additional adjunct components. The precise nature of these additional adjunct components, and levels of incorporation thereof, will depend on the physical form of the composition and the nature of the operation for which it is to be used. The adjunct ingredients may be in the solid free flowing particulate laundry detergent composition or any of its particle populations like the spray dried base detergent particle population or the other detergent particle population and may be present in the aqueous base slurry or the aqueous polymer base slurry. Suitable adjunct materials include, but are not limited to, builder, flocculating aid, chelating agents, dye transfer inhibitors, enzymes, enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, and/or pigments. In addition to the disclosure below, suitable examples of such other adjuncts and levels of use are found in U.S. Pat. Nos. 5,576,282, 6,306,812 B1 and 6,326,348 B1 that are incorporated by reference. Such one or more adjuncts may be present as detailed below:

BUILDER—The detergent composition may comprise one or more builders. When a builder is used, the subject composition will typically comprise from 1% to about 40%, typically from 2 to 25%, or even from about 5% to about 20%, or from 8 to 15% by weight of builder.

The detergent compositions of the present invention comprise from 0 to 20%, in particular less than 15% or 10%, for example less than 5% of zeolite. In particular, the detergent composition comprises from 0 to 20%, in particular less than 15% or 10%, for example less than 5% of aluminosilicate builder(s).

The detergent composition of the present invention may comprise from 0 to 20%, in particular less than 15% or 10%, for example less than 5% of phosphate builder and/or silicate builder and/or zeolite builder.

The detergent compositions of the present invention may comprise from 5 to 20% of sodium carbonate.

Builders include, but are not limited to, the alkali metal, ammonium and alkanolammonium salts of polyphosphates, alkali metal silicates, layered silicates, such as SKS-6 of Clariant®, alkaline earth and alkali metal carbonates, aluminosilicate builders, such as zeolite, and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, fatty acids, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

FLOCCULATING AID—The composition may further comprise a flocculating aid. Typically, the composition comprises at least 0.3% by weight of the composition of a flocculating aid. The composition may also be substantially free of flocculating aid. Typically, the flocculating aid is polymeric. Typically the flocculating aid is a polymer comprising monomer units selected from the group consisting of ethylene oxide, acrylamide, acrylic acid and mixtures thereof. Typically the flocculating aid is a polyethyleneoxide. Typically the flocculating aid has a molecular weight of at least 100,000 Da, in particular from 150,000 Da to 5,000,000 Da or even from 200,000 Da to 700,000 Da.

BLEACHING AGENT—The compositions of the present invention may comprise one or more bleaching agents. In general, when a bleaching agent is used, the compositions of the present invention may comprise from about 0.1% to about 50% or even from about 0.1% to about 25% bleaching agent by weight of the subject detergent composition. When present, suitable bleaching agents include bleaching catalysts, photobleaches for example Vitamin K3 and zinc or aluminium phtalocyanine sulfonate; bleach activators such as tetraacetyl ethylene diamine (TAED) and nonanoyloxybenzene sulphonate (NOBS); hydrogen peroxide; pre-formed peracids; sources of hydrogen peroxide such as inorganic perhydrate salts, including alkali metal salts such as sodium salts of perborate (usually mono- or tetra-hydrate), percarbonate, persulphate, perphosphate, persilicate salts and mixtures thereof, optionally coated, suitable coatings including inorganic salts such as alkali metal; and mixtures thereof.

The amounts of hydrogen peroxide source and peracid or bleach activator may be selected such that the molar ratio of available oxygen (from the peroxide source) to peracid is from 1:1 to 35:1, or even 2:1 to 10:1

FLUORESCENT WHITENING AGENT—The composition may contain components that may tint articles being cleaned, such as fluorescent whitening agent. When present, any fluorescent whitening agent suitable for use in a detergent composition may be used in the composition of the present invention. The most commonly used fluorescent whitening agents are those belonging to the classes of diaminostilbene-sulphonic acid derivatives, diarylpyrazoline derivatives and bisphenyl-distyryl derivatives.

Typical fluorescent whitening agents are Parawhite KX, supplied by Paramount Minerals and Chemicals, Mumbai, India; Tinopal® DMS and Tinopal® CBS available from Ciba-Geigy AG, Basel, Switzerland. Tinopal® DMS is the disodium salt of 4,4′-bis-(2-morpholino-4 anilino-s-triazin-6-ylamino)stilbene disulphonate. Tinopal® CBS is the disodium salt of 2,2′-bis-(phenyl-styryl)disulphonate.

FABRIC HUEING AGENTS—Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof.

POLYMERIC DISPERSING AGENTS—the compositions of the present invention can contain additional polymeric dispersing agents. These polymeric dispersing agents, if included, are typically at levels up to about 5%, typically from about 0.2% to about 2.5%, more typically from about 0.5% to about 1.5%. Suitable polymeric dispersing agents, include polymeric polycarboxylates, substituted (including quarternized and oxidized) polyamine polymers, and polyethylene glycols, such as: acrylic acid-based polymers having an average molecular of about 2,000 to about 10,000; acrylic/maleic-based copolymers having an average molecular weight of about 2,000 to about 100,000 and a ratio of acrylate to maleate segments of from about 30:1 to about 1:1; maleic/acrylic/vinyl alcohol terpolymers; polyethylene glycol (PEG) having a molecular weight of about 500 to about 100,000, typically from about 1,000 to about 50,000, more typically from about 1,500 to about 10,000; and water soluble or dispersible alkoxylated polyalkyleneamine materials.

POLYMERIC SOIL RELEASE AGENT—The compositions of the present invention can also contain polymeric soil release agent. polymeric soil release agent, or “SRA”, have hydrophilic segments to hydrophilize the surface of hydrophobic fibers such as polyester and nylon, and hydrophobic segments to deposit upon hydrophobic fibers and remain adhered thereto through completion of washing and rinsing cycles, thereby serving as an anchor for the hydrophilic segments. This can enable stains occurring subsequent to treatment with the SRA to be more easily cleaned in later washing procedures. Preferred SRA's include oligomeric terephthalate esters; sulfonated product of a substantially linear ester oligomer comprised of an oligomeric ester backbone of terephthaloyl and oxyalkyleneoxy repeat units and allyl-derived sulfonated terminal moieties covalently attached to the backbone; nonionic end-capped 1,2-propylene/polyoxyethylene terephthalate polyesters; an oligomer having empirical formula (CAP)₂(EG/PG)₅(T)₅(SIP)₁ which comprises terephthaloyl (T), sulfoisophthaloyl (SIP), oxyethyleneoxy and oxy-1,2-propylene (EG/PG) units and which is typically terminated with end-caps (CAP), typically modified isethionates, as in an oligomer comprising one sulfoisophthaloyl unit, 5 terephthaloyl units, oxyethyleneoxy and oxy-1,2-propyleneoxy units in a defined ratio, typically about 0.5:1 to about 10:1, and two-end-cap units derived from sodium 2-(2-hydroxyethoxy)-ethanesulfonate; oligomeric esters comprising: (1) a backbone comprising (a) at least one unit selected from the group consisting of dihydroxy sulfonates, polyhydroxy sulfonates, a unit which is at least trifunctional whereby ester linkages are formed resulting in a branched oligomer backbone, and combinations thereof; (b) at least one unit which is a terephthaloyl moiety; and (c) at least one unsulfonated unit which is a 1,2-oxyalkyleneoxy moiety; and (2) one or more capping units selected from nonionic capping units, anionic capping units such as alkoxylated, typically ethoxylated, isethionates, alkoxylated propanesulfonates, alkoxylated propanedisulfonates, alkoxylated phenolsulfonates, sulfoaroyl derivatives and mixtures thereof. Preferred are esters of the empirical formula:

((CAP)ₐ(EG/PG)_{b}(DEG)_{c} PEG)_{d}(T)ₑ(SIP)_{f}(SEG)_{g}(B)ₕ)

wherein CAP, EG/PG, PEG, T and SIP are as defined hereinabove, DEG represents di(oxyethylene)oxy units, SEG represents units derived from the sulfoethyl ether of glycerin and related moiety units, B represents branching units which are at least trifunctional whereby ester linkages are formed resulting in a branched oligomer backbone, a is from about 1 to about 12, b is from about 0.5 to about 25, c is from 0 to about 12, d is from 0 to about 10, b+c+d totals from about 0.5 to about 25, e is from about 1.5 to about 25, f is from 0 to about 12; e+f totals from about 1.5 to about 25, g is from about 0.05 to about 12; h is from about 0.01 to about 10, and a, b, c, d, e, f, g, and h represent the average number of moles of the corresponding units per mole of the ester; and the ester has a molecular weight ranging from about 500 to about 5,000.; and; cellulosic derivatives such as the hydroxyether cellulosic polymers available as METHOCEL® from Dow; the C₁-C₄ alkyl celluloses and C₄ hydroxyalkyl celluloses, see U.S. Pat. No. 4,000,093, issued Dec. 28, 1976 to Nicol et al., and the methyl cellulose ethers having an average degree of substitution (methyl) per anhydroglucose unit from about 1.6 to about 2.3 and a solution viscosity of from about 80 to about 120 centipoise measured at 20° C. as a 2% aqueous solution. Such materials are available as METOLOSE SM100® and METOLOSE SM200®, which are the trade names of methyl cellulose ethers manufactured by Shinetsu Kagaku Kogyo KK.

ENZYME—The composition of the invention may further comprise an enzyme. When present in the detergent composition, the enzymes may be present at levels from about 0.00001% to about 2%, from about 0.0001% to about 1% or even from about 0.001% to about 0.5% or 0.02% enzyme protein by weight of the composition.

Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof.

ENZYME STABILIZERS—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

CATALYTIC METAL COMPLEXES—The compositions of the invention may comprise catalytic metal complexes. When present, one type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

SOFTENING SYSTEM—the compositions of the invention may comprise a softening agent such as clay for softening through the wash. The composition may additionally comprise a charged polymeric fabric-softening boosting component.

COLORANT—the compositions of the invention may comprise a colorant, typically a dye or a pigment. Particularly, preferred dyes are those which are destroyed by oxidation during a laundry wash cycle. To ensure that the dye does not decompose during storage it is preferable for the dye to be stable at temperatures up to 40° C. The stability of the dye in the composition can be increased by ensuring that the water content of the composition is as low as possible. If possible, the dyes or pigments should not bind to or react with textile fibres. If the colorant does react with textile fibres, the colour imparted to the textiles should be destroyed by reaction with the oxidants present in laundry wash liquor. This is to avoid coloration of the textiles, especially over several washes. Particularly, preferred dyes include but are not limited to Basacid® Green 970 from BASF and Monastral blue from Albion.

The detergent composition is typically a laundry detergent composition.

The detergent composition is in free-flowing particulate form. The composition can be made by methods such as dry-mixing, agglomerating, compaction, spray drying, pan-granulation, spheronization or any combination thereof.

The detergent composition may be capable of cleaning and/or softening fabric during a laundering process. Typically, the detergent composition is formulated for use in an automatic washing machine or for hand-washing use.

### Process to Prepare the Solid Free Flowing Particulate Laundry Detergent Composition

According to one of the embodiment of the invention, the solid free flowing particulate laundry detergent composition is obtained by a process comprising the step of preparing an aqueous common base slurry comprising on a dry basis:
from 6 wt % to 45 wt % of alkylbenzene sulphonate, and a total amount of anionic surfactant of from 6 wt % to 45 wt %,
from 20 wt % to 84 wt % of a compound selected from sodium sulphate, alluminosilicate builder, phosphate builder, from salts of chloride, carbonate, citrate, bicarbonate, and mixtures thereof,
from 0 wt % to 10 wt % of polymeric material,
from 0 wt % to 10 wt % of other ingredients.

According to one of the embodiment of the invention, the solid free flowing particulate laundry detergent composition is obtained by a process comprising the step of preparing an aqueous polymer base slurry comprising on a dry basis:
from 1 wt % to 100 wt % of polymeric material,
from 0 wt % to 6 wt % of alkylbenzene sulphonate, and a total amount of anionic surfactant of from 0 wt % to 35 wt %,
from 0 wt % to 99% of other ingredients,

According to one of the embodiment of the invention, the solid free flowing particulate laundry detergent composition is obtained by a process comprising the step of obtaining a spray dried powder from the common base slurry and the aqueous polymer base slurry by spray drying them,

According to one of the embodiment of the invention the weight ratio of the percentage of polymeric material in the aqueous common base slurry to the percentage of polymeric material in the aqueous polymer base slurry is below 0.8, preferably below 0.5 or 0.25 or 0.2, and may be above 0.01.

According to one of the embodiment of the invention the weight ratio of the percentage of alkylbenzene sulphonate in the aqueous polymer base slurry to the percentage of alkylbenzene sulphonate in the aqueous common base slurry is below 0.8 preferably below 0.5 or 0.25 or 0.2 and may be above 0.01.

According to one of the embodiment of the invention the weight ratio of the percentage of anionic surfactant in the aqueous polymer base slurry to the percentage of alkylbenzene sulphonate in the aqueous common base slurry is below 0.8 preferably below 0.5 or 0.25 or 0.2 and may be above 0.01.

According to one of the embodiment of the invention the weight ratio of the percentage of anionic surfactant in the aqueous polymer base slurry to the percentage of anionic surfactant in the aqueous common base slurry is below 0.8 preferably below 0.5 or 0.25 or 0.2 and may be above 0.01.

The process to prepare the solid free flowing particulate laundry detergent composition may comprise additional step, like adding other detergent ingredients. Additional detergent ingredients may be added as dry add, agglomerate, may be sprayed as liquid on the spray dry particules or may be added by any suitable mean.

### Aqueous Common Base Slurry

The aqueous common base slurry may comprises on a dry basis from 10 wt % or 15 wt % or 20 wt % to 30 wt % of alkylbenzene sulphonate,

The aqueous common base slurry may comprises on a dry basis a total amount of anionic surfactant of 10 wt % or 15 wt % or from 20 wt % to 30 wt %,

The aqueous common base slurry may comprise on a dry basis from 30 wt % to 70 wt % of sodium sulphate.

The aqueous common base slurry may comprises on a dry basis from 0 wt % to 30 wt %, preferably from 10 wt % to 20 wt %, of a salt selected from salts of chloride, carbonate, citrate, bicarbonate, and mixture thereof, in particular of sodium carbonate.

The aqueous common base slurry may comprise on a dry basis from 0 wt % to 3 wt % of polymeric material.

The aqueous common base slurry may comprise on a dry basis less than 5 wt % of other ingredient than the one mentioned above.

The aqueous common base slurry may comprise from 25% to 50% of water.

The aqueous common base slurry may comprise less than two other ingredient than the one mentioned above.

In the aqueous common base slurry, the ratio of polymeric material to alkylbenzene sulphonate is preferably below 0.9, preferably below 0.3 preferably below 0.1 or even below 0.06.

In the aqueous common base slurry, the ratio of silicate salt to total anionic surfactant is preferably above 0.02, preferably above 0.06.

### Aqueous Polymer Base Slurry

The aqueous polymer base slurry may comprise on a dry basis from 5 wt % to 70 wt % of polymeric material.

The aqueous polymer base slurry may comprise on a dry basis from 0 wt % to 4 wt % of alkylbenzene sulphonate.

The aqueous polymer base slurry may comprise on a dry basis a total amount of anionic surfactant of from 0 wt % to 20 wt % or from 1 wt % to 15 wt %.

The aqueous polymer base slurry may comprise on a dry basis from 0 wt % to 97 wt % of sodium sulphate.

The aqueous polymer base slurry may comprise on a dry basis from 0 wt % to 25 wt % of cationic surfactant.

The aqueous polymer base slurry may comprise on a dry basis from 0 wt % to 97 wt % of silicate salt.

The aqueous polymer base slurry may comprise on a dry basis from 0 wt % to 97 wt % of a salt selected from salts of chloride, carbonate, citrate, bicarbonate, and mixture thereof.

The aqueous polymer base slurry may comprise on a dry basis from 0 wt % to 5 wt % of chelant.

The aqueous polymer base slurry may comprise on a dry basis from 0 wt % to 5 wt % of brightener.

The aqueous polymer base slurry may comprise on a dry basis from 0 wt % to 20 wt % of magnesium sulfate.

The aqueous polymer base slurry may comprise on a dry basis from 0 wt % to 5 wt % of chelant.

The aqueous polymer base slurry may comprise on a dry basis from 0 wt % to 50 wt % of clay.

The aqueous polymer base slurry may comprise from 25% to 50% of water.

The aqueous polymer base slurry may comprise on a dry basis from 0 wt % to 10 wt % of other ingredients than the one mentioned above.

The aqueous polymer base slurry may comprise less than two other ingredient than the one mentioned above.

In the aqueous polymer base slurry, the ratio of polymeric material to alkylbenzene sulphonate is preferably below 0.9, preferably below 0.6, preferably below 0.3 or 0.2 and may be above 0.01 or above 0.1.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Unless otherwise specified, ratio and percentage are in weight.

The following examples are given by way of illustration only and therefore should not be construed to limit the scope of the invention.

### EXAMPLES

### Example 1

### Process to Make a Solid Free Flowing Particulate Laundry Detergent Composition

Aqueous Common Base Slurry.

| | Aqueous slurry | Aqueous slurry |
|---|---|---|
| | (weight parts) | (weight parts) |
| Component | Wet basis | Dry basis |
| LAS (45% wt aqueous) | 58.8889 | 27 |
| Sodium Silicate (45% wt aqueous) | 11.7674 | 5 |
| Acrylate/maleate copolymer (40% wt | 2.5000 | 1 |
| aqueous) | | |
| Sodium carbonate (100 wt % | 13.7564 | 14 |
| anhydrous) | | |
| Sodium sulphate (100 wt % anhydrous) | 52.2387 | 52 |
| Water | 4.0232 | |
| Aqueous alkaline slurry parts | 143.1745 | 100 |

the alkaline aqueous slurry having the composition as described above is prepared in a slurry making vessel (crutcher). The alkaline aqueous slurry is shear thinning and has a viscosity in the range of from 0.5 to 30 Pas at a temperature of 70° C. and at a shear rate of 50 s⁻¹. The moisture content of the above slurry is 31.0%. Any ingredient added above in liquid form is heated to 70° C., such that the aqueous slurry is never at a temperature below 70° C. Saturated steam at a pressure of 6.0×10⁵ Pa is injected into the crutcher to raise the temperature to 90° C. The slurry is then pumped into a low pressure line (having a pressure of 5.0×10⁵ Pa).

The mixture is then sprayed (simultaneously with an aqueous polymer slurry, cf below) at a rate of 1,640 kg/hour at a pressure of 8.0×10⁶ Pa and at a temperature of 90° C.+/−2° C. through a spray pressure nozzle into a counter current spray-drying tower with an air inlet temperature of 290° C.

Aqueous Polymer Base Slurries A, B, and C

| | A | | B | | C | |
|---|---|---|---|---|---|---|
| | Wet Basis | Dry Basis | Wet Basis | Dry Basis | Wet Basis | Dry Basis |
| LAS (45% wt | 1.0309 | 2.3135 | 1.3747 | 2.5560 | 0.0000 | 0.0000 |
| aqueous) | | | | | | |
| Sodium Silicate | 3.7842 | 8.4924 | 2.5337 | 4.7110 | 4.6899 | 47.4462 |
| (45% wt | | | | | | |
| aqueous) | | | | | | |
| Acrylate/maleate | 4.5969 | 9.1701 | 3.2104 | 5.3060 | 5.8443 | 52.5538 |
| copolymer (40% | | | | | | |
| wt aqueous) | | | | | | |
| Sodium sulphate | 15.0000 | 74.8051 | 20.0000 | 82.635 | 0.0000 | 0.0000 |
| (100 wt % | | | | | | |
| anhydrous) | | | | | | |
| Brightener 15 | 0.0432 | 0.2154 | 0.0000 | 0.0000 | 0.0000 | 0.0000 |
| (100 wt % solid) | | | | | | |
| EDTA (39% wt | 1.3851 | 2.6940 | 0.4987 | 0.8040 | 0.0000 | 0.0000 |
| aqueous) | | | | | | |
| MgSO4 solution | 2.0587 | 2.3100 | 0.6178 | 2.501 | 0.0000 | 0.0000 |
| (22.5% wt) | | | | | | |
| HEDP (Na Form) | 0.0000 | 0.0000 | 1.2012 | 1.4870 | 0.0000 | 0.0000 |
| Water | 4.0000 | 0.0000 | 6.0000 | 0.0000 | 1.0000 | 0.0000 |
| Total Parts | 28.4120 | 100.0000 | 35.4364 | 100.0000 | 11.5343 | 100.0000 |

An aqueous polymer base slurry having the composition A, B or C as described above is prepared in a slurry making vessel with sufficient agitation to ensure good suspension of ingredients. The aqueous slurry at a temperature of 50° C. is pumped into a pressurized line (having a pressure of 7.0×10⁶ Pa) through a spray pressure nozzle. This polymer base aqueous slurry will be sprayed simultaneously with the aqueous common base slurry into a counter current spray-drying tower with an air inlet temperature of 300° C.

Both mixtures are atomised and the atomised slurries are dried simultaneously, which is then cooled and sieved to remove oversize material (>1.8 mm) to form a spray-dried powder, which is free-flowing. Fine material (<0.15 mm) is elutriated with the exhaust the exhaust air in the spray-drying tower and collected in a post tower containment system. The spray-dried powder has a moisture content between 1.0 wt % to 2.5 wt % and particle size distribution such that greater than 80 wt % of the spray-dried powder has a particle size of from 150 to 710 micrometers. The composition of the resulting spray-dried powder is given below.

Spray-dried powder

| | % w/w Spray Dried Powder | | |
|---|---|---|---|
| Component | A | B | C |
| LAS | 17.4737 | 14.7054 | 24.1460 |
| Sodium Silicate | 6.2211 | 4.8001 | 8.6651 |
| Acrylate/maleate copolymer | 3.9563 | 3.0502 | 5.4629 |
| Sodium carbonate (100 wt % | 8.9517 | 7.2551 | 12.9944 |
| anhydrous) | | | |
| Sodium sulphate (100 wt % | 59.9440 | 66.1568 | 47.5982 |
| anhydrous) | | | |
| Brightener 15 (100 wt % solid) | 0.0782 | 0.0000 | 0.0000 |
| EDTA | 0.9779 | 0.3849 | 0.0000 |
| MgSO4 | 0.8385 | 1.1981 | 0.0000 |
| HEDP (Na) | 0.0000 | 0.7125 | 0.0000 |
| Water | 1.5585 | 1.7368 | 1.1334 |
| Total Parts | 100.0000 | 100.0000 | 100.0000 |

Additional ingredients are added to the spray dried powder.

Solid free flowing particulate laundry detergent composition

| | % w/w granular laundry | | |
|---|---|---|---|
| | detergent composition | | |
| | A | B | C |
| Spray-dried powder of example 1 | 55.2407 | 50.5283 | 51.3589 |
| (described above) | | | |
| RV Base | 0.6897 | 1.0053 | 1.2414 |
| Zeolite | | 0.4000 | |
| AE3S | | 3.8500 | |
| Sodium percarbonate (having from | 4.9938 | 11.4210 | 10.0250 |
| 12% to 15% active AvOx) | | | |
| Sodium Carbonate Anhydrous | 16.3971 | 11.9554 | 19.2003 |
| Citric Acid Anhydrous | | 1.0000 | 0.5000 |
| Lipase (11.00 mg active/g) | | 0.0800 | 0.3200 |
| Amylase (21.55 mg active/g) | 0.1378 | | |
| Protease (56.00 mg active/g) | 0.1944 | | 0.2000 |
| Tetraacetyl ethylene diamine | 0.2400 | 1.5200 | 1.2100 |
| agglomerate (92 wt % active) | | | |
| Blocky CMC | 0.3979 | | |
| Brightener 15 (100 wt % solid) | | 0.1000 | 0.1125 |
| Suds suppressor agglomerate | 0.2000 | 0.2581 | 0.1306 |
| (11.5 wt % active) | | | |
| Acrylate/maleate copolymer | | 2.3000 | |
| particle (95.7 wt % active) | | | |
| Green/Blue carbonate speckle | 0.5000 | 0.5000 | 1.0000 |
| Solid perfume particle | 0.2143 | | 0.0000 |
| Perfume Liquid | 0.3465 | 0.1700 | 0.5906 |
| Ethoxylated C₁₂-C₁₈ alcohol having | 0.6897 | 0.5200 | 0.8100 |
| an average degree of ethoxylation | | | |
| of 7 (AE7) | | | |
| Sodium Sulphate | Balance | Balance | Balance |
| Total Parts | 100.00 | 100.00 | 100.00 |

The above laundry detergent composition was prepared by dry-mixing all of the above particles (all except the AE7, RV Base & Perfume liquid) in a standard batch mixer. The AE7 in liquid form is sprayed on the particles in the standard batch mixer. Alternatively, the AE7 in liquid form is sprayed onto the spray-dried powder. The resultant powder is then mixed with all of the other particles in a standard batch mixer.

### Example 2

### A Solid Free Flowing Particulate Laundry Detergent Composition

Spray-Dried Base Detergent

| | |
|---|---|
| Linear alkylbenzenesulphonate | 9 |
| Sodium silicate | 7 |
| Maleic/acrylic co-polymer | 1 |
| Sodium carbonate | 10 |
| Sodium sulphate | 16 |
| Water | 1 |

Dry-Added Particles

| | |
|---|---|
| Light Density Silicate dry-add (Ineos P10) | 15 |
| Chelant particle | 0.5 |
| PEG-grafted polyethylene glycol polymer agglomerate | 0.5 |
| Hueing particle (DV66) | 0.5 |
| Dense Coated Sodium Percarbonate | 15 |
| TAED agglomerates | 4 |
| Spray-dried maleic/acrylic co-polymer | 4 |
| Brightener particle | 0.5 |
| Cationic surfactant particle | 2 |
| Ethoxylated alcohol sulphate particle | 5 |
| Dye transfer inhibitor | 0.5 |
| Protease | 0.5 |
| Lipase | 0.5 |
| Cellulase | 0.5 |
| Amylase | 0.5 |
| Repellotex | 1 |
| Perfume microcapsule particle | 0.75 |
| Silicone sud suppressor | 0.5 |
| Speckle | 2 |

Liquid Spray-On

| | |
|---|---|
| Non-ionic surfactant | 1 |
| Perfume | 0.7 |
| moisture/misc | to 100 |

The bulk density distribution of the final composition comprises at least 15 parts less than 400 g/l and at least 15 parts greater than 1000 g/l. The bulk density of the full composition is between 600 and 800 g/l.

The density distribution can be determined by use of classification techniques such as a zig-zag classifier (eg from Hosokawa Micron) in combination with particle size classification.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid free flowing particulate laundry detergent composition comprising:
(i) from 30 wt % to 90 wt % of a spray dried base detergent particle population comprising:
(a) from 10 wt % to 45 wt % of anionic detersive surfactant, wherein the anionic detersive surfactant comprises alkylbenzene sulphonate;
(b) from 20 wt % to 84 wt % of a compound selected from: sulphate salt; alluminosilicate builder; phosphate builder; chloride salt; carbonate salt; citrate salt; bicarbonate salt; hydroxide salt; and mixtures thereof;
(c) from 0 wt % to 20 wt % of polymeric material; and
(d) from 0 wt % to 10 wt % water and other detergent ingredients,
wherein the base detergent particle population comprises no more than two other detergent ingredients; and
(ii) from 10 wt % to 70 wt % other detergent particle populations comprising:
(a) from 1 wt % to 100 wt % of polymeric material;
(b) from 0 wt % to less than 10 wt % of anionic detersive surfactant;
(d) from 0 wt % to 4 wt % chelant;
(e) from 0 wt % to 4 wt % brightener;
(f) from 0 wt % to 4 wt % hueing agents;
(g) from 0 wt % to 99 wt % bleach;
(h) from 0 wt % to 40 wt % clay;
(i) from 0 wt % to 30 wt % cationic surfactant; and
(j) from 0 wt % to 99% of other ingredients,
wherein at least 5 wt % of the particles have a bulk density of less than 400 g/l, wherein at least 15 wt % of the particles have a bulk density of greater than 900 g/l, and wherein the bulk density of the particulate composition is in the range of from 500 g/l to 800 g/l.

2. A composition according to claim 1, wherein the weight ratio of the percentage of polymeric material in the base detergent particle population to the percentage of polymeric material in the other detergent particle populations is below 0.8.

3. A composition according to claim 1, wherein the weight ratio of the percentage of anionic surfactant in the other detergent base detergent particle population to the percentage of alkylbenzene sulphonate in the detergent base detergent particle population is below 0.8.

4. A composition according to claim 1, wherein the composition comprises from 0.5 wt % to 5 wt % liquid ingredients that are absorbed onto at least part of the particles.

5. A process for preparing a solid free flowing particulate laundry detergent composition comprising the steps of:
(i) preparing an aqueous common base slurry comprising on a dry basis:
from 6 wt % to 45 wt % of alkylbenzene sulphonate, and a total amount of anionic surfactant of from 6 wt % to 45 wt %,
from 20 wt % to 84 wt % of a compound selected from sodium sulphate, alluminosilicate builder, phosphate builder, from salts of chloride, carbonate, citrate, bicarbonate, and mixtures thereof,
from 0 wt % to 10 wt % of polymeric material,
from 0 wt % to 10 wt % of other ingredients,
(ii) preparing an aqueous polymer base slurry comprising on a dry basis:
from 1 wt % to 100 wt % of polymeric material,
from 0 wt % to 6 wt % of alkylbenzene sulphonate, and a total amount of anionic surfactant of from 0 wt % to 35 wt %,
from 0 wt % to 99% of other ingredients,
(iii) obtaining a spray dried powder from the common base slurry and the aqueous polymer base slurry by spray drying them,
wherein the weight ratio of the percentage of polymeric material in the aqueous common base slurry to the percentage of polymeric material in the aqueous polymer base slurry is below 0.8, and
wherein the weight ratio of the percentage of alkylbenzene sulphonate in the aqueous polymer base slurry to the percentage of alkylbenzene sulphonate in the aqueous common base slurry is below 0.8.

6. A process according to claim 5, wherein the weight ratio of the percentage of polymeric material in the aqueous common base slurry to the percentage of polymeric material in the aqueous polymer base slurry is below 0.2.

7. A Process according to claim 5, wherein the weight ratio of the percentage of alkylbenzene sulphonate in the aqueous polymer base slurry to the percentage of alkylbenzene sulphonate in the aqueous common base slurry is below 0.2.

8. A Process according to claim 5, wherein the weight ratio of polymeric material to alkylbenzene sulphonate in the aqueous common base slurry is below 0.06.

9. A Process according to claim 5, wherein the weight ratio of alkylbenzene sulphonate to polymeric material in the aqueous polymer base slurry is below 0.2.

10. A Process according to claim 5, wherein the aqueous common base slurry comprises on a dry basis:
from 15 wt % to 30 wt % of alkylbenzene sulphonate, and a total amount of anionic surfactant of from 15 wt % to 30 wt %,
from 30 wt % to 70 wt % of sodium sulphate,
from 0 wt % to 30 wt % of a salt selected from salts of chloride, carbonate, citrate, bicarbonate, and mixture thereof,
from 0 wt % to 3 wt % of polymeric material,
from 0 wt % to 5 wt % of other ingredients.

11. A Process according to claim 5, wherein the aqueous polymer base slurry comprises on a dry basis:
from 5 wt % to 70 wt % of polymeric material,
from 0 wt % to 4 wt % of alkylbenzene sulphonate, and a total amount of anionic surfactant of from 0 wt % to 20 wt %,
from 0 wt % to 97 wt % of sodium sulphate,
from 0 wt % to 25 wt % of cationic surfactant,
from 0 wt % to 97 wt % of silicate salt,
from 0 wt % to 97 wt % of a salt selected from salts of chloride, carbonate, citrate, bicarbonate, and mixture thereof,
from 0 wt % to 5 wt % of chelant,
from 0 wt % to 5 wt % of brightener,
from 0 wt % to 20 wt % of magnesium sulfate,
from 0 wt % to 5 wt % of chelant,
from 0 wt % to 50 wt % of clay,
from 0 wt % to 10 wt % of other ingredients.

12. A Process according to claim 5, wherein free flowing particulate laundry detergent composition comprise at least 30 wt % of spray dried ingredients coming from the aqueous common base slurry, and at least 10 wt % of spray dried ingredient coming from the aqueous polymer base slurry.

13. A Process according to claim 5, wherein the free flowing particulate laundry detergent composition is as defined in claim 1.
